(19) United States
(12) Patent Application Publication
(10) Pub. No.: US 2014/0006040 A1
(43) Pub. Date: Jan. 2, 2014

(54) HOME HEALTHCARE SYSTEM INCLUDING MEDICATION ADMINISTRATION SYSTEM AND METHOD OF DISPENSING MEDICINES

(71) Applicants: Mika APELL, Turku (FI); Jyrki NIINISTÖ, Halikko (FI)

(72) Inventors: Mika APELL, Turku (FI); Jyrki NIINISTÖ, Halikko (FI)

(73) Assignee: EVONDOS OY, Salo (FI)

(21) Appl. No.: 13/538,416

(22) Filed: Jun. 29, 2012

(51) Int. Cl. G06Q 50/22

(52) U.S. Cl. 705/2

(57) ABSTRACT

Method, arrangement and apparatus for administrating dispensing medication in which the arrangement receives user information to authorize access of a user according to defined user roles to control patient care events. The arrangement receives care related information for the patient based on the user information defining the user role in the arrangement. A medication item to be taken by the patient is then detected and item information of at least one detected medication item is read. By comparing the item information with care related information the patient is authorized to receive the medication item. A reminder can be set to allow the patient to receive the medication item on a delivery time based on the care related and item information. Upon receiving the medication item on the delivery time, the actual delivery time together with item information is communicated to acknowledge the reminder.

### TECHNICAL FIELD

This invention relates to home healthcare system. More particularly, the invention relates to home healthcare, medication administration systems and methods of dispensing medicines.

### BACKGROUND

Traditionally medication administration requires a lot of manual work from care giving persons who usually are medical or healthcare personnel, but also close relatives to the patients or the patients themselves who may be involved in or do administration. Manual medication administration work contains several different tasks which cannot be associated as direct care work: The care givers have to dispense the medicines from packages to manual or automated dispensers such as pill boxes which process requires great carefulness and responsibility from the care givers. They often visit patients to ensure that the patients will take or have taken the right dose at the right time. The care givers fetch medicines for patients from pharmacies every time when any individual medicine runs out. Consequently, patients' home supply of medicine is refilled irregularly.

Medication administration is crucial to the patient. The traditional medication administration causes anxiety and distress for care givers and other parties like close relatives and patients themselves because it is very difficult to know if the medicines have been taken properly or not. Care givers and other parties like close relatives and the patients themselves are worried even if professionals are managing medication administration in a traditional way. The problems are compounded in the traditional medication administration when multiple medicines need to be taken.

Mistakes and oblivion are common in conventional medication administration. Homes are stocked with big amounts of medicines which may lead to misuse of drugs by the patients or other parties. There are a lot of dedicated solutions for supporting medication administration but many of them resolve only a small part of the problems in home healthcare and are not compatible with each other. Such solutions are, for example, traditional pill boxes, manually refillable manual and automated dispensers, medication reminders, healthcare data systems, etc. However, it is not easy to integrate a system for effective medication administration from conventional dedicated components, because there usually is some incompatibility between components or missing parts that impedes the integration. This also concerns integration to other systems needed in home healthcare. Existing traditional or automated dispensers have to be refilled pill-by-pill which requires a lot of manual error-prone work. Typically, conventional dispensers are rather awkward to use or they don't take sufficiently into account different users who possess different abilities to use technical devices. Also conventional dispensers being developed to support automated dose dispensing processes are complicated to use by patients or care givers.

There are thus difficulties to provide traditional devices and solutions of medication administration to be suitable for different care environments and different user needs.

### SUMMARY OF THE INVENTION

The objectives of the invention are achieved by providing for a patient the automatic delivery of right medication dosage at right time and that the delivery process is easy to administrate for the patient and other persons who are involved in the care process and having different user roles. The invention provides a simple, easy to use and secure way for medication dispensing and medication administration.

In accordance with a first aspect of the invention there is provided a method which comprises
receiving user information to authorize access of a user to control care events of a patient,
receiving care related information for the patient based on the user information,
detecting medication item comprising a dosage to be taken at the same point of time,
reading item information of at least one detected medication item,
comparing the item information with the care related information to ensure that the patient is allowed to receive the medication item,
setting a reminder to the patient about the available medication item within a delivery time window based on the care related information and item information, and
communicating, upon receiving the medication item within the delivery time window, an acknowledgement of the reminder.

In accordance with a second aspect of the invention there is provided a dispensing apparatus which comprises
a user interface configured to receive user information to authorize access of a user to control care events of a patient,
a receiver configured to receive care related information for the patient based on the user information,
a detector configured to detect medication item comprising a dosage to be taken at the same point of time,
a reader configured to read item information of at least one detected medication item,
a processor configured to compare the item information with the care related information to ensure the patient is allowed to receive the medication item,
the processor configured to set a reminder to the patient about the available medication item within a delivery time window based on the care related information and item information, and
a transmitter configured to communicate, upon receiving the medication item within the delivery time window, an acknowledgement of the reminder.

In accordance with a third aspect of the invention there is provided an arrangement which comprises
an apparatus comprising a processor and a memory comprising a computer program, where the memory and the computer program together with the processor cause the apparatus to perform
receiving user information to authorize access of a user to control care events of a patient,
receiving care related information for the patient based on the user information,
detecting medication item comprising a dosage to be taken at the same point of time,
reading item information of at least one detected medication item,
comparing the item information with the care related information to ensure that the patient is allowed to receive the medication item,
setting a reminder to the patient about the available medication item within a delivery time window based on the care related information and item information, and
communicating, upon receiving the medication item within the delivery time window, an acknowledgement of the reminder, and
a server being communicatively connected to the apparatus so as to remotely monitor and administrate the apparatus.

In accordance with a fourth aspect of the invention there is provided an apparatus which comprises a processor and a memory comprising a computer program, where the memory and the computer program together with the processor cause the apparatus to perform
receiving user information to authorize access of a user to control care events of a patient,
receiving care related information for the patient based on the user information,
detecting medication item comprising a dosage to be taken at the same point of time,
reading item information of at least one detected medication item,
comparing the item information with the care related information to ensure that the patient is allowed to receive the medication item,
setting a reminder to the patient about the available medication item within a delivery time window based on the care related information and item information, and
communicating, upon receiving the medication item within the delivery time window, an acknowledgement of the reminder.

In accordance with a fifth aspect of the invention there is provided a computer program which comprises program code means adapted to perform the method of any of the method claims, when said program is run on a computer.

Embodiments of the invention are presented in dependent claims.

An advantage of the invention is that taking the medicine is very safe and simple for the patient, because medication is delivered only when it is allowed to be taken and the patient can easily receive the dosage by pushing or touching a single button. At the same, upon pushing or touching a single button or registering with an RFID/NFC token, the patient acknowledges to the system that he/she has taken the medicine and the time it was received by the patient. The medicine delivery process is monitored by the medication administration system.

A further advantage of the invention is that the system reminds the patient to take the medication. In addition to that the device itself reminds to take the medication, the patient may receive the reminder to his/her wireless or wired communication device even in remote places.

A further advantage of the invention is to provide for other parties such as relatives, nurses or other responsible care givers information about medication and delivery events and if problems in medication delivery occur an alarm to the mentioned other parties is communicated. This makes the medicine delivery process safe and informative so that all parties, independent of their position, are kept aware of the process continuously and realized care in real time. The other parties don't need to go to the patient's home to be sure that everything is alright. Concerning care continuity and critical non-compliance issues, the system sends remote alarms and ensures that the alarms are received and acknowledged by responsible persons. The system provides remote visibility e.g. via Internet.

A further advantage of the invention is that the medication administration system including the medicine delivery process is secure to use, because user authorization and authentication is required from all users accessing to the system and all user initiated operations are logged in the system. Users may have different user roles and they are authorized to access the system, configure system and monitor or use information according to the user role that has been defined for them. For example, medication compliance data is accessible securely for the users having a user role authorized to use the system and monitor the individual patient.

A further advantage of the invention is to provide a platform that supports integration to other healthcare, safety, messaging and pharmacy systems and devices. The dispensing apparatuses are communicatively connectable to local peripherals for home healthcare and safety, such as blood pressure meters, pulse meters, etc. Servers that communicate with the dispensing apparatuses also communicate with patient databases, and healthcare, safety, communication and pharmacy systems. For example, the servers communicate with the automated dose dispensing devices to provide them with relevant care related information being related to the patient.

A further advantage of the invention is that medication can be delivered from the packages that are automatically dose dispensed in factory environment. These packages are composed of medication items where each item contains medication to be taken by the patient at the same point of time. These packages are for easy transportation and loading to the dispensing apparatuses. Regular medication supply to the patient's home is easy to manage and there is not any need to store unnecessary amounts of medicines at home which prevents misuse of drugs.

Various embodiments of the invention together with additional objects and advantages will be best understood from the following description of specific embodiments when read in connection with the accompanying drawings.

### BRIEF DESCRIPTION OF THE DRAWINGS

An embodiment of the invention will be described in detail below, by way of example only, with reference to the accompanying drawings, of which

FIG. 1 depicts as a flow chart an example of a method according to the aspects of the disclosed embodiments,

FIG. 2 depicts as a block diagram an example of an arrangement in which aspects of the disclosed embodiments may be applied, and

FIG. 3 depicts as a block diagram an example of an apparatus in which aspects of the disclosed embodiments may be applied.

### DETAILED DESCRIPTION OF THE DRAWINGS

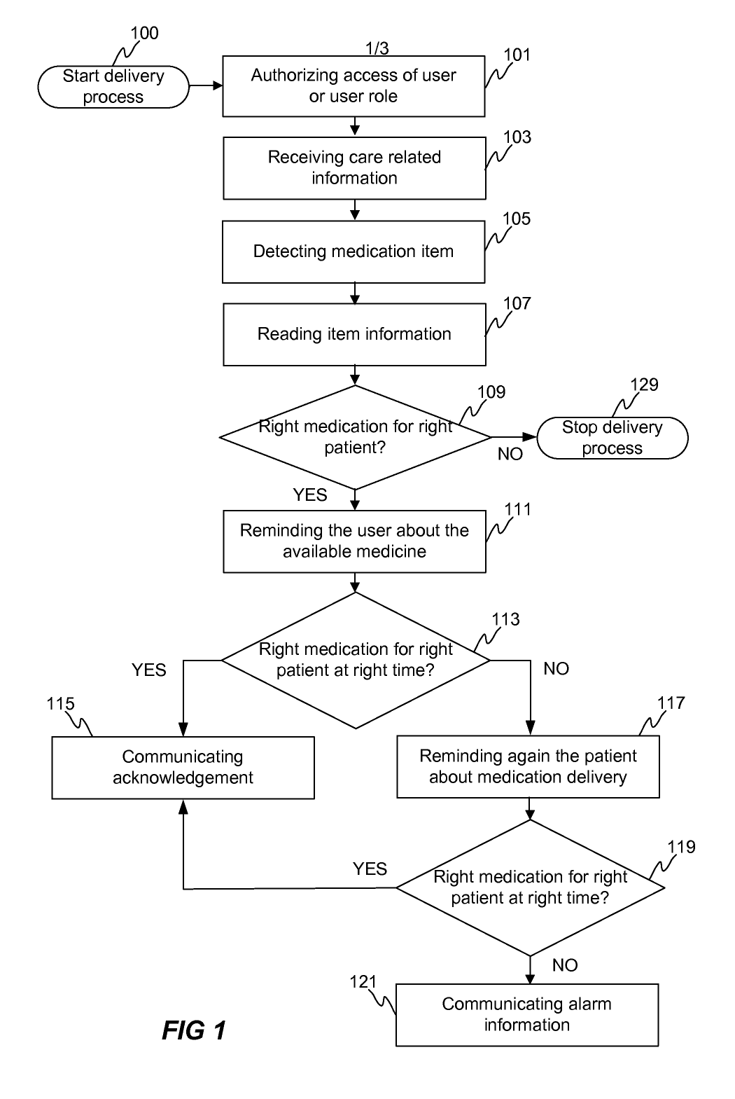

FIG. 1 is a flow chart of an example of a method according to the aspects of the disclosed embodiments for providing information about dispensing medication. In step 100 a user starts medication dispensing process. For example, the user enters user information by means of a user interface. User information comprises at least user identification data to identify the user. User information comprising at least user identification data is maintained in databases. In step 101 user information is received to authorize access of a user to control care events of a patient. Access authorization is optional if the user is a patient. Access authorization is always needed for other users than the patient. The user enters user information via a user interface which is communicatively connected to a server based medication administration system. User information comprises, for example, user identity information. The user can give the user information by entering user name and password locally or remotely, using an electrical key such as an RFID tag, using secured ID cards, using NFC key code of the mobile phone, or other secured authentication methods.

In a method according to an example based on the received user information in step 101 the user is defined to have a user status as a patient and is then allowed to access the system as the patient. However, step 101 is optional in case the user has a user status as a patient and has access to only receive the medication item from the dispenser. Dispensing apparatus with its medication delivery process is typically allocated to a particular patient. Therefore it is important to be sure that the right patient is authorized to access this particular apparatus. This is important if there is a risk that e.g. a child or other unauthorized person may have access to receive medication from the dispenser. As an example, the additional user authentication can be made by entering an additional code to the user interface or reading an RFID key code from RFID tag to recognize the patient in order to allow the patient to receive the medication item. Once the user accesses the dispensing apparatus as a patient to receive the medication item, he/she is allowed to use the apparatus according to automated medication dispensing procedure which means that he/she only needs to follow instructions given to him/her and give an acknowledgement when required. However, step 101 is required in case the user has a user status as a patient and he/she is also allowed to refill the dispenser with new medication items. Then the user having the user status as a patient is also authorized to refill the medicine chamber of the dispenser with new medication items such as new medication packages, a new matrix of blister packages or a new strip of pouches where each package or pouch comprises medication dosage to be taken at the same point of time. New strips of pouches are available, for example, in pharmacies offering automated dose dispensing processes. In order to refill the medicine chamber may also require additional user authentication e.g. by entering an additional code to the user interface to recognize the patient or by using a key to open a locked delivery chamber. Additional user authentication can also be made by reading a RFID user code from RFID tag to recognize the patient. According to step 101 the patient may have access to the server based medication administration system. Then, the user is allowed to access servers and dispensing apparatuses and other entities communicating with the servers and the dispensing apparatuses. The patient as a user may monitor logs of his/her dispenser status, dispenser logs, medication compliance status and medication compliance logs. The user as a patient may also configure and maintain the system entities. These tasks are flexibly adjustable in a range depending on patient's capability level.

In a method according to an example based on the received user information in step 101 the user is defined to have a user status other than a patient and is then allowed to access the system in this user role. The user may have a user role as a close relative, nurse, doctor or other care giving or medication administrating person or party. Different user roles have different rights to access the system. New user roles can be dynamically added to the system. When the user is authorized to access in other user role than a patient, the user may be, based on his/her role allowed to access servers and dispensing apparatuses and other entities communicating with the servers and the dispensing apparatuses. Bearers of these other user roles than a patient may be allowed to access medication administration systems, where medication and care information relating to the patients is accessible. The rights of each user role are defined individually. Servers are used to monitor, review and administrate the dispensing apparatuses and medication compliance of the patients. The care related information comprises information about patient related medication compliance. Bearers of other user roles than a patient are allowed to monitor medication delivery for the particular patient from the dispensing apparatus. Also the particular patient him/herself is allowed to monitor his/her medication delivery from the apparatus. All user initiated operations, independent of the authorized user role, are traceable, because they are logged into servers in the medication administration system. The user having the user role other than a patient is authorized to refill the medicine chamber of the dispenser with new medication items if this particular user role is authorized to do so. He/she is also allowed to do maintenance or configuration relating to the dispensing apparatuses or the servers. According to the bearer's user role information the bearer may be allowed to access servers and dispensing apparatuses and other entities communicating with the servers and the dispensing apparatuses. The bearer is allowed to monitor and administrate the dispensing apparatuses and the server based medication administration system. At the same time, the patient and the bearer of other user role than the patient can have authorized access to the dispensing apparatus according to their user roles.

In a method according to an example user role can be allocated to care organizations so that organizational information is received for authorizing access of a bearer of the user role, wherein the bearer of the user role is a care organization. For example, administration stuff and care givers belong to one or more organizations. For example, patients and dispensers belong to one care organization. For example, Turku can be care organization which contains patients from Turku area. For example, patient can only access his own dispenser but care givers and administration stuff can access all the dispensers in their care organization. Care organizations can be divided into sub care organizations, e.g. based on care areas.

In step 103, based on the user information care related information for the user is received. Care related information relating to the patients is maintained in databases. Care related information may be also received locally by the user who is authorized to do so. Care related information is typically administrated by doctors, pharmacists and other healthcare staff having authorization to do so. Thus, users who have afore-mentioned user roles have access to server based care related information administration. Care related information comprises information about dosage to be taken at the same point of time, delivery time telling at what time the dosage has to be taken and other such information about medicament. All operations about medication compliance are logged into servers in the medication administration system. Users having authorized user role can review status and logs information locally and remotely. The user who has the user role as a patient may also in some cases access to review his/her care related information but the user role as a patient is typically not authorized to access to administrate care related information. However, the patient as a user may also have a user role as a care giver for himself/herself and then the patient is authorized to access the system as a care giver for the patient who is himself/herself.

In step 105 medication item is detected where the medication item comprises a dosage to be taken at the same point of time by the patient. Individual medication items can be recognized, for example, using pattern recognizing methods. The medication item has either been packed with automated dose dispending process or not. Medication items can be packed in a strip of pouches or individual pouches, blisters, boxes, cans, or other dosage containing packages. Medication item can also be a separate package containing e.g. insulin, mixtures or other medication which is not suitable for automated dose dispending process. Medication item can also be a separate or continuous sheet comprising only an indication to the dosage to be taken at the same point of time meanwhile the dosage itself is stored in a place where the patient takes it within the delivery time.

In a method according to an example medication item is available to the patient in a strip of pouches, where each pouch comprises a medication dosage to be taken at the same point of time. The strip is assembled in the medicine chamber of the dispenser. The strip can be for example roll-shaped or folded. Step 105 comprises detecting individual pouches in the strip of pouches, wherein the individual pouch comprises a dosage to be taken at the same point of time.

In step 107 item information is read from the medication item. Item information can be printed, labeled, adhered or otherwise attached to each medication item. Here the medication item can also be a separate or continuous sheet where item information may also comprise an indication to the dosage to be taken at the same point of time from a separate place by the patient. Item information can be in a form of a print layout with text, 1D bar code, 2D bar code or other print layout or RFID tag. Item information comprises at least information about delivery time of the content of the particular medication item. Also reference to the patient's user information and care related information may include to item information. Delivery time indicates the time when the patient has to take the dosage containing in the medication item. Delivery time can also be a time window comprising a certain period of time defined by two predetermined time points during which period the patient has to take the dosage. The user having a user role authorized to access the system for medication administration can adjust delivery times or time windows from the server or the dispensing apparatus.

In a method according to an example, in step 107 item information of each detected individual pouch is read. Item information can be printed, labeled, adhered or otherwise attached to each pouch in the strip of pouches during automated or manual dose dispensing process. Typically, dose dispensing packages are made in pharmacies, hospitals, health clinics or in other premises where factory environment is realized.

In a method according to an example, item information of several successive detected individual medication items are read at the same time. For example, item information of individual pouches in the strip is read at the same time. For example, when three successive medication items are read in-one-go also item information comprising delivery times for the three successive medication items are found out. This reveals easily if there is more than one medication item that has to be delivered at the same time to the patient. It is not unusual that the patient has to take, for example, content of two individual medication items at the same time. Thus, by reading several successive medication items and their item information the dispensing apparatus has a readiness to delivery more than one medication item at the same point of time if several medication items have the same delivery times.

In step 109 the item information is compared with the care related information to authorize the user to receive the at least one individual medication item. Item information and care related information comprise certain references to each other, for example, reference to user identity information. Item information and care related information or at least one of them comprises the delivery time of the dosage. If the comparison in step 109 matches the read item information with care related information of this particular patient then a reminder is set for the user. In step 111 a reminder is set to a user interface to allow the patient to receive the at least one medication item on a delivery time based on item information. In an example, delivery time can be based on care related information or item information. The reminder reminds the patient, about taking the medication and it comprises at least the delivery time of the dosage. The reminder is in the form of readable text or any visible, audible or spoken signal, or other such message or signal. The reminder is sensed by the user from the user interface, e.g. display, loud speaker or buzzer. If the comparison in step 109 reveals that the read item information does not correspond with care related information of the patient then the delivery process of this particular medication item is stopped in step 129. This means that the patient who has authorized access to the dispensing apparatus is not allowed to receive the particular item of dosage which is ready for next delivery. In this case the particular medication item is conveyed to a dedicated container in association to the dispensing apparatus. Or the particular pouch is cut off from the strip and is conveyed to a dedicated container in association to the apparatus. After step 129 the delivery process is started again from step 100.

In a method according to an example after setting a reminder in step 111 the reminder is communicated wirelessly or using wired line to a patient. The dispensing apparatus can remind the patient via its user interface and/or the reminder can be communicated wirelessly or using wired line to a user interface of the communication device of the patient. In an example, the reminder is remotely communicated to the communication device of the patient.

In step 113 the patient has a possibility to receive the medication item of dosage from the dispensing apparatus in a delivery time. If the patient does not take the medication item during the delivery time, the reminder is again communicated to the patient just before the delivery time ends according to step 117. In most cases the delivery time is defined to be the time window comprising a first and second time points between which the patient has to take the dosage comprising one or more medication items. In this case, if the patient does not take the medication item by a certain point of time between the first and second time point, the reminder is again communicated to the patient according to step 117. Several other points of time between the first and second time point can be set to trigger the reminder for the patient in step 117. A sequence to trigger the reminder quickens towards the second time point of the time window. The delivery time window has to end well before a delivery time of next ordinary medication item delivery so that medication dispensing overall is not interrupted. After the reminder has been repeated once or more often during the delivery time period according to step 117, the patient has a possibility to receive the medication item of dosage from the dispensing apparatus within delivery time in step 119. If the patient does to take the medication item during the delivery time, an alarm can be communicated to the communication device of the user having a user role other than a patient according to step 121. If necessary, steps 117 and 119 can be passed and according to step 121 an alarm is communicated to the communication device of the user having a user role other than a patient just after “no” response in step 113. Thus, the users who are authorized to access to monitor patient's medication taking, are informed of discontinuity in medication taking. However, by all means unnecessary alarms should be avoided but all user actions need to be logged. In practice there is not usually any need to give the alarm according to step 121 if the patient has missed only one delivery time with medication items. The missed medication item is just conveyed to the container box of missed medication items in association with the dispensing apparatus, and the delivery process continues from step 100 (or 103 if authorizing not required) for next delivery time with one or more medication items. However, if the patient has missed several consecutive delivery times with medication items, the alarm is communicated according to step 121 to the user having a user role other than a patient. It is also possible to define that certain medication items are obliged to be taken when their turn is. In that case the dispenser waits, even if the delivery time window is already passed, until the patient has taken the dosage before continuing to step 100 for next delivery.

The reminder and the alarm can be remotely communicated wirelessly or using wired line to the communication devices of the users. When the user receives an alarm message and he/she opens and acknowledges the alarm message, an acknowledge message is communicated to the server based medication administration system. Upon giving an alarm in step 121 the particular medication item that was meant to be delivered within this particular delivery time is conveyed to a dedicated container in association with the apparatus. Or the particular pouch is cut off from the strip and conveyed to the dedicated container in association with the apparatus. After step 121 the delivery process is started again from step 100 (or 103 if authorizing not required).

If the patient receives the medication item of dosage from the dispensing apparatus in a delivery time in step 113 or in step 119, he/she simultaneously acknowledges the delivery in step 115. The acknowledgement comprises, for example, communicating the delivery time and the item information to the server based medication administration system. The acknowledgement of the reminder comprises updating care related information for the patient and storing information related to dispensing events and medical care events to the server based medication administration system.

For example, the patient has to push a button in the user interface in order to receive the medication item or items the content of which has to be taken at the same point of time during the delivery time window. In an example, when the patient pushes the button the medicine item is fed out of the dispenser. At the same time when the patient pushes the button he/she also acknowledges the reminder by communicating the delivery time and the item information. Alternatively, the patient touches a button or a corresponding area on a touch screen of the apparatus to receive the medication item and to acknowledge the reminder. The patient may also enter a predetermined code to the user interface to receive the medication item and to acknowledge the reminder. Alternatively, the patient communicates a RFID/NFC authorization to the user interface of the apparatus to receive the medication item and to acknowledge the reminder.

In a method according to an example an additional authentication request can be required for a user having the user status as a patient if there is a risk that e.g. a child or other unauthorized person may have access to receive medication item from the dispenser. Then the user has to take the additional secure measures before receiving the item of dosage from the dispensing apparatus. Such measures are, e.g. entering an additional code to the user interface or using an RFID or NFC tag or smart card to recognize the patient or opening the locked delivery chamber by using a key.

In a method according to an example communication with healthcare, safety and pharmacy entities enables to receive additional information related to the user information, the care related information and the item information. For example, care related data can be automatically transferred from one entity to another by means of the server based medication administration system. For example, home healthcare accessories can be integrated to the system to communicate with the dispensing apparatuses. The server based system, dispensing apparatuses communicatively connected with the servers and accessories communicatively connected with the dispensing apparatuses or servers can all communicate with each other. The dispensing apparatus communicates regularly messages to the servers so that the server in the medication administration system knows if the dispensing apparatus is operational and that the server can establish communication with the dispensing apparatus.

In a method according to an example communication with database entities enables to store, retrieve and maintain the user information and the care related information related to the user as well as information related to dispensing events and medical care events.

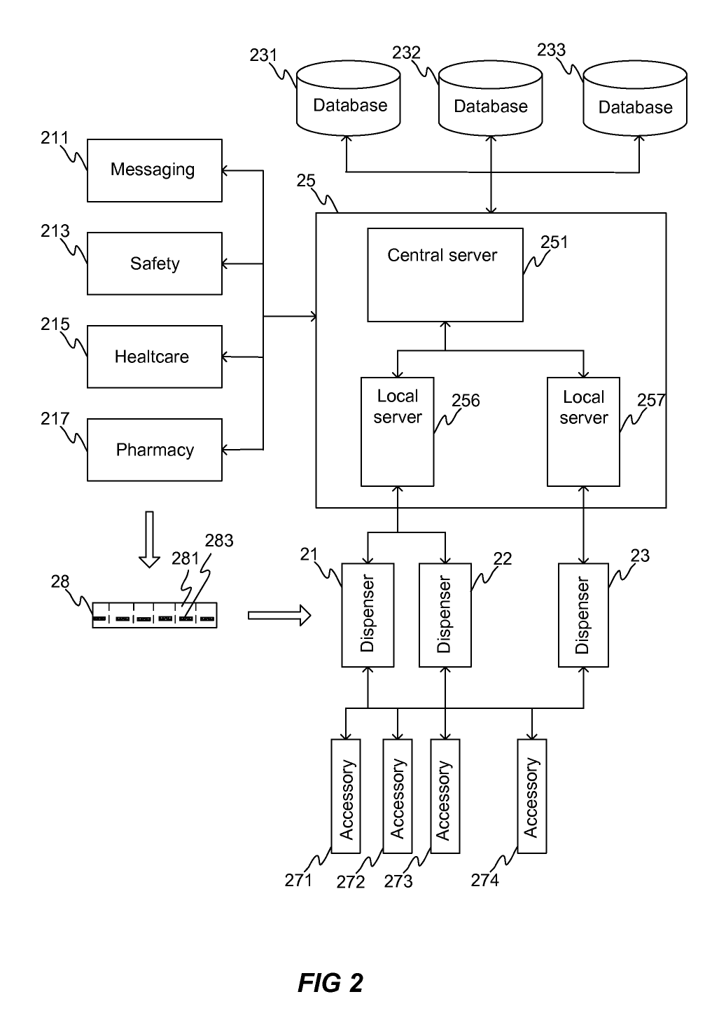

FIG. 2 shows block diagram of an arrangement according to an example for providing medication administration. The arrangement comprises a server system 25 comprising at least a central server 251 for centralized arrangement management, backup and data archiving. Also at least one local server 256, 257 may include in the server system 25. Local servers 256, 257 are, for example, country based servers. The server system 25 is communicatively connected to databases 231, 232, 233 comprising, for example, data relating to patient, healthcare and safety issues. Communicative connection means that two-way data communication is locally or remotely possible using wireless or wired connections. On the other hand, the databases 231, 232, 233 can be situated in servers 251, 256, 257 in the server system 25. The server system 25 is also communicatively connected to external systems such as messaging system 211 for remote messaging, safety system 213 for secured service integration, healthcare system 215 for service integration and/or pharmacy system 217 for automated dose dispensing processes or medical regimen. The servers 251, 256, 257 in the server system 25 comprise data transfer means configured to communicate with afore-mentioned external systems.

The arrangement comprises at least one dispensing apparatus 21, 22, 23 that is communicatively connected to the server system 25. Typically, the dispensing apparatus 21, 22, 23 locates at patient's apartment. The dispensing apparatus 21, 22, 23 is configured to deliver medication items to the patient who has been authorized to access the apparatus to receive the medication item. In an example, the medication items are packed in individual packages that are assembled into the dispensing apparatus 21, 22, 23. Each package comprises item information as earlier discussed. In another example, the medication item is an individual pouch 283 in the strip 28 of pouches as shown in FIG. 2. Each pouch 281 comprises item information as earlier discussed. In an example, a folded or roll shaped strip 28 comprising dosages dispensed by automated dose dispensing process is supplied from e.g. the pharmacy (see arrows in FIG. 2) and is assembled into the dispensing apparatus 21, 22, 23. Medication items are preferably locked into a fixed or detachable delivery chamber of the dispensing apparatus 21, 22, 23 so that unauthorized users and persons do not have access therein.

The dispensing apparatuses 21, 22, 23 are locally communicatively connected to local peripheral accessories 271-274 that provide more information about health and safety of the users of the dispensing apparatuses 21, 22, 23. Such accessories 271-274 are e.g. blood pressure and pulse rate meters, etc. For example, the dispensing apparatus 21, 22, 23 and accessories 271-274 are locally communicatively connected to each other using ZigBee, USB, Bluetooth or USB dongle based short range connections.

In an arrangement according to an example at least one dispensing apparatus 21-23, 31 is communicatively connected to at least one server 251, 256, 257 in the server system 25. The arrangement is configured to receive user role information for authorizing access of a bearer of the user role, wherein the bearer of the user role is other than a patient and/or receive user information for authorizing access of the patient. The arrangement is also configured to receive at least care related information for the patient based on the user information. The arrangement is also configured to receive item information being printed, adhered or otherwise attached to medication items. Individual medication item comprises a dosage to be taken at the same time by the patient. To receive item information the arrangement is configured to detect individual medication items and read item information of at least one detected individual medication item. The arrangement is configured to compare the item information with the care related information to authorize the patient to receive the medication item and set a reminder to a user interface to allow the patient to receive the medication item on a delivery time based on care related information or item information. The arrangement is configured to communicate, when the patient receives the medication item on the delivery time, the actual delivery time and item information to acknowledge the reminder. The arrangement is communicatively connected to communication means configured to transmit and/or receive information to/from the patient, and transmit and/or receive information to/from the bearer of the user role.

In an arrangement according to an example messaging system 211 is in connection with the arrangement used to communicate reminders, alarms, user information, care related information, administration information or other such information to and from users who are authorized to access the arrangement according to their user roles. Messaging system 211 provides information to users by means of user interfaces of the communication devices. In an example, the user can be authorized to access the arrangement by remotely entering user identification such as name and password via the user interface of the communication device.

In an arrangement according to an example the server system 25 is in connection with safety system 213 to provide data security for service integration. The safety system 213 is a software entity that controls, for example, user authorizations, medication compliance for the patient, medication delivery in compliance with delivery time, etc. All user operations are communicated with the safety system 213 being integrated with server system 25 of the arrangement.

In an arrangement according to an example the server system 25 is in connection with the pharmacy system 217 having an automated dose dispensing system so as to provide the automated dose dispensing system with user or care related information received by the arrangement which information is relevant for item information of medication items during packaging or dispensing the medication items.

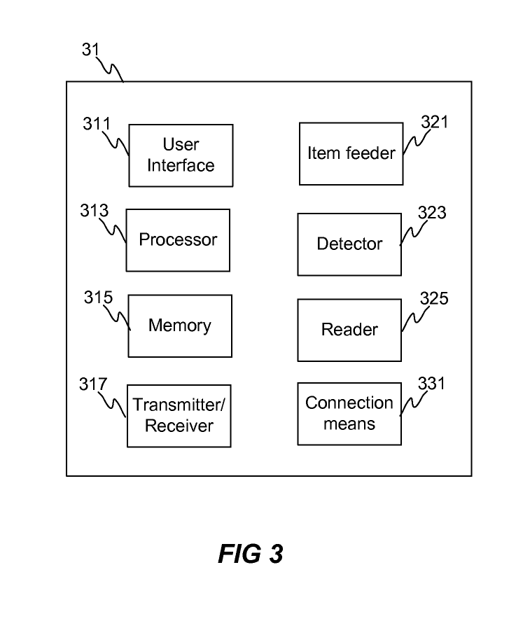

FIG. 3 shows block diagram of an apparatus 31 according to an example for dispensing medication items. The apparatus 31 comprises a processor 313 and a memory 315. The memory 315 stores computer program instructions that control the operation of the apparatus 31 when loaded into the processor 313. The computer program instructions provide the logic and routines that enables the apparatus 31 to perform the method steps described earlier in this application.

The apparatus 31 comprises a user interface 311 configured to enter at least user information and display the reminder to the patient. The user interface 311 comprises a button that can be pushed or touched to acknowledge certain functions. Or the user interface 311 comprises means to interact with RFID/NFC authentication key to acknowledge certain functions. Said functions include acknowledging to the server system 25 delivery of the medication item. The patient can see from the display of the user interface 311 the reminder telling that it is time to take the medication item. After this the patient pushes or touches the button of the user interface 311 or enters RFID/NFC authentication key and an item feeder 321 of the apparatus 31 feeds the medication item to be available for the patient. For safety reasons the patient may need to give evidence, as earlier already discussed, to be authorized to before receiving the medication item so that delivery for unauthorized persons is prevented.

The apparatus 31 further comprises a detector 323 configured to detect individual medication items. When the individual medication item is recognized the reader 325 is configured to read the item information from the individual medication item. If the patient misses the reminded delivery time window and the medication item should not be delivered at all, this particular medication item is conveyed to a dedicated chamber of the apparatus 31. After this the apparatus 31 is ready to deliver the next medication item according to the schedule.

The apparatus 31 comprises connection means 331 for integrating local peripheral accessories 271-274 to locally communicate with the apparatus 31. The connection means 331 comprises fixed wireless interfaces or flexible dedicated interfaces for external accessories needs. The connection means 331 is configured to receive health information for the patient from the peripheral accessory 271-274 assigned to the patient. Said received information can be transmitted further to the server 25 by the transmitter 317. The connection means 331 is also configured to transmit care related information for the patient to the peripheral accessory 271-274 assigned to the patient. Said transmitted information can be received from the server 25 by the receiver 317. In an example, the connection means 331 comprises ZigBee interface and mobile data. In another example, the connection means 331 comprises Zigbee gateway, USB sticks for optional wired or wireless interfaces like Bluetooth or other reservations by internal hardware connectors. The connection means 331 can be added and enabled/disabled by authorized users based on their user roles. For example, only authorized users can have access to USB sticks for external accessories 271-274 when the USB sticks are assembled behind the medication chamber lid. By entering the user information or other secure information by means of the user interface 311 the user can then open a lock of the medication chamber lid. Information received from accessories 271-274 can be used to administrate care related information relating to the patient who is the user of the dispensing apparatus 21-23, 31 by persons having user roles being authorized to access the server based medication administration. Said information is communicated from the accessories 271-274 to servers 251, 256, 257 and databases 231-233 in the server based medication administration arrangement. Care related information is also communicated from servers 251, 256, 257 and databases 231-233 in the server based medication administration arrangement to the accessories 271-274, for example, to configure the accessories 271-274 for the particular patient according to his/her care needs. All the two-way communication between the accessories 271-274 assigned for a particular patient and the servers 25 is directed through the dispensing apparatus 21-23, 31 assigned for this particular patient when communicating health and/or care related information to one direction or another.

The apparatus 31 comprises a transmitter/receiver 317 for locally or remotely communicating with server system 25 for administrating medication dispensing. The server 25 is configured to monitor the apparatus 31 and medication compliance of the patents. In the arrangement communication is secured and only users (user roles) authorized can access. In an example, the apparatus 31 sends regularly messages to the server 25 so that the server 25 knows that the apparatus 31 is operational and that communication between the server 25 and the apparatus 31 can be established. Communication can be handled by simple non-encrypted keep alive messages because information sent in keep alive messages is non-sensitive. The apparatus 31 is authenticated by using one or more secret keys which is different for every apparatus 31 so that the server 25 knows that it is the right apparatus 31 in question. Secret keys can be changed by using secured connection. Also for other sensitive data such as configurations, user related data, etc., the apparatus 31 opens secured connection.

In an apparatus according to an example a database is maintained for users and user roles who will be authorized to access to the apparatus 31. In an example, the database is maintained in the memory 315 of the apparatus 31. Users and user roles of the individual apparatus 31 are updated by communication between the servers 251, 256, 257 and the dispensing apparatus 21-23, 31.

A computer program according to an example comprises program code means adapted to perform the method steps depicted in FIG. 1, when said program is run on a computer.

It will be understood that each block of the flow chart illustration, and combinations of blocks in the flow chart illustration, can be implemented by computer program instructions. These program instructions may be provided to a processor to produce a machine, such that instructions, which execute on the processor, create means for implementing the actions specified in the flow chart block or blocks. The computer program instructions may be executed by a processor to cause a series of operational steps to be performed by the processor to produce a computer implemented process such that the instructions, which execute on the processor providing steps for implementing the actions specified in the flow chart block or blocks.

Accordingly, blocks of the flow chart illustration support combinations of means for performing the specified actions, combination of steps for performing the specified actions and program instructions means for performing the specified actions. It will also be understood that each block of the flow chart illustration, and combinations of blocks in the flow chart illustration, can be implemented by special purpose hardware-based systems which perform the specified actions or steps, or combination of special purpose hardware and computer instructions.

If desired, the different functions discussed herein may be performed in a different order and/or concurrently with each other. Furthermore, if desired, one or more of the above-described functions may be optional or may be combined.

While this invention has been described with reference to illustrative embodiments, this description is not intended to be construed in a limiting sense. Various other embodiments of the invention will be apparent to persons skilled in the art upon reference to this description. It is therefore contemplated that the appended claims will cover any such modifications of the embodiments as fall within the true scope of the invention.

1. A method, comprising
receiving user information to authorize access of a user to control care events of a patient,
receiving care related information for the patient based on the user information,
detecting medication item comprising a dosage to be taken at the same time,
reading item information of at least one detected medication item,
comparing the item information with the care related information to ensure that the patient is allowed to receive the medication item,
setting a reminder to the patient about the available medication item within a delivery time window based on the care related and item information, and
communicating, upon receiving the medication item within the delivery time window, an acknowledgement of the reminder.

2. A method according to claim 1, comprising communicating the reminder to the patient if at least one predetermined time point within the delivery time window is passed, wherein communicating comprises transmitting the reminder to communication means.

3. A method according to claim 1, communicating an alarm to the user if the acknowledgement of the reminder has not been communicated for a certain number of times, wherein communicating comprises transmitting the alarm to communication means.

4. A method according to claim 1, wherein communicating the acknowledgement of the reminder comprises updating care related information for the patient and storing information related to dispensing events and medical care events.

5. A method according to claim 1, wherein detecting medication item comprises detecting individual medication items in the strip of multiple medication items, wherein the individual medication item comprises a dosage to be taken at the same point of time and item information relates to the individual medication item.

6. A method according to claim 1, wherein reading item information comprises simultaneous reading of the item information of adjacent individual medication items so as to determine if several medication items need to be delivered during the same delivery time window.

7. A method according to claim 1, wherein the patient acknowledges the reminder by pushing a button or by touching an area on a touch screen.

8. A method according to claim 1, wherein the patient acknowledges the reminder by using an RFID, NFC or other ID tag.

9. A method according to claim 1, wherein the reminder is displayed and/or is given as an audible or spoken signal to the patient.

10. A method according to claim 1, comprising communicating with external healthcare, messaging, safety and/or pharmacy entities to receive or transmit care related information for the patient according to the user information.

11. A method according to claim 1, comprising communicating with database entities to store, retrieve and maintain care related information and information related to dispensing events and medical care events according to the user information.

12. A method according to claim 1, comprising monitoring, reviewing and administrating care related information for the patient and functions related to dispensing events and medical care events according to the user information.

13. A dispensing device, comprising
a user interface configured to receive user information to authorize access of a user to control care events of a patient,
a transmitter/receiver configured to transmit or receive care related information for the patient based on the user information,
a detector configured to detect medication item comprising a dosage to be taken at the same point of time,
a reader configured to read item information of at least one detected medication item,
a processor configured to compare the item information with the care related information to ensure that the patient is allowed to receive the medication item,
the processor configured to set a reminder to the patient about the available medication item within a delivery time window based on the care related information and item information, and
the transmitter/receiver configured to communicate, upon receiving the medication item within the delivery time window, an acknowledgement of the reminder.

14. A dispensing device according to claim 13, comprising connection means configured to receive or transmit care related information for the patient from/to at least one local healthcare accessory.

15. An arrangement, comprising
an apparatus comprising a processor and a memory comprising a computer program, where the memory and the computer program together with the processor cause the apparatus to perform the method of claim 1, and
a server being communicatively connected to the apparatus so as to remotely monitor the apparatus.

16. An arrangement according to claim 15, wherein the server provides the reminder or the alarm to the communication means.

17. An arrangement according to claim 15, wherein the server is communicatively connected to external healthcare systems, messaging systems, safety systems and/or pharmacy systems.

18. An arrangement according to claim 15, wherein the apparatus is communicatively connected to at least one local healthcare accessory configured to receive or transmit care related information for the patient.
